(19) United States
(12) Patent Application Publication
(10) Pub. No.: US 2006/0158004 A1
(43) Pub. Date: Jul. 20, 2006

(54) Recreational vehicle with enhanced hauling capability

(75) Inventors: Theodore V. Harris, Somerset, PA (US); Brooke M. Borek, Somerset, PA (US); Dana K. Gehman, Somerset, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Fleetwood Folding Trailers, Inc.

(21) Appl. No.: 11/328,983

(22) Filed: Jan. 10, 2006

Related U.S. Application Data
(60) Provisional application No. 60/645,275, filed on Jan. 19, 2005.

(51) Int. Cl. B60P 3/35

(52) U.S. Cl. 296/176

(57) ABSTRACT

The trailer, for example a folding camping trailer, is adapted to be pulled by a towing vehicle and has an enhanced accessory hauling capability for hauling outdoor use accessories. The trailer includes an elongated chassis and a trailer body attached to the chassis. The trailer body includes two sidewalls, two connecting end walls, a roof portion, and base. The sidewalls, end walls, roof portion, and base define an internal living space of the trailer body. The trailer body further includes at least one slide-out area extendable outward from one of the sidewalls of the trailer body for expanding the living space of the trailer body. A deck is attached to the chassis adjacent one of the end walls, and is sized to accommodate one or more of the outdoor use accessories thereon. The slide-out area may be moved to the extended position with the accessories positioned on the deck.

### CROSS REFERENCE TO RELATED APPLICATION

The present application claims priority to U.S. Application No. 60/645,275 filed Jan. 19, 2005 and entitled “Recreational Vehicle With Enhanced Hauling Capability”, the disclosure of which is incorporated herein in its entirety.

### BACKGROUND OF THE INVENTION

1. Field of the Invention

The present invention relates generally to recreational vehicles such as travel trailers, fifth-wheelers, folding camping trailers, and hybrids thereof and, more particularly, a folding camping trailer having the capability of hauling small and large scale outdoor use accessories, often referred to as toys.

2. Background and Description of Related Art

In the recreational vehicle industry, there are two major types or categories of vehicles, namely motorized and towable vehicles. Motorized recreational vehicles (“RV's) are self-propelled and may be driven. Towable RV's, or trailers, have one or more axles and require a coupling device for engaging a mating towing hitch on a towing vehicle. The invention to be disclosed herein relates generally to towable RV's or trailers.

Towable RV's or trailers have three general forms and include travel trailers, fifth-wheelers, and folding camping trailers. Conventional travel trailers and fifth-wheelers have solid, full-height sidewalls, end walls, a fixed roof, and floor. The sidewalls, end walls, roof, and floor form the internal living space of the travel trailer or fifth-wheeler. It is common in travel trailers and fifth-wheelers to have an outward extendable slide-out room or living space, generally referred to as slide-outs or slide-out areas. One such example is disclosed in U.S. Pat. No. 6,561,570 to Gehman et al. assigned to the same assignee as the present application and which is incorporated herein by reference in its entirety.

Folding camping trailers, by contrast, do not have full-height sidewalls. Folding camping trailers generally have a floor panel, two partial-height sidewalls, two partial-height end walls, and a vertically extendable roof section. To expand the useable living space, folding camping trailers typically include a flexible, typically fabric (i.e., tented) section or enclosure extending from the roof section to the sidewalls and end walls. When the roof section is in the extended or raised position, the fabric enclosure or, alternatively, folding rigid panels may be deployed between the roof section and sidewalls and end walls to form an enclosed living space. The fabric enclosure or folding rigid panels may be referred to as the living enclosure of the folding camping trailer. Folding camping trailers may include extendable sleep areas or extendable slide-out areas in much the same manner as travel trailers. An example of a folding camping trailer with extendable sleep areas is generally described in U.S. Pat. No. 6,217,106 Reckner, Jr. assigned to the same assignee as the present application and which is incorporated herein by reference in its entirety. In this disclosure, the term “slide-out area” and like phrases is intended to encompass slide-out areas such as that disclosed in the Gehman et al. patent and extendable sleep areas such as that disclosed in the Reckner, Jr. patent. In the retracted or “down” position of the roof section and living enclosure, the folding camping trailer provides a lightweight, low-profile vehicle that is easily towed.

A recent evolution in the RV industry combines the solid walls of a travel trailer with the lighter weight expandability of folding camping trailers in a single unit and are referred to as “hybrids”. Hybrids have the stowed appearance of a travel trailer but when set-up for occupancy they feature a slide-out area or sleep area with a fabric (i.e., tented) enclosure. An example of a hybrid trailer is disclosed in U.S. Pat. No. 5,992,920 to Bailey et al., the disclosure of which is incorporated by reference in its entirety. Some recent hybrid trailers known in the art even include an extendable roof section for increased headroom within the travel trailer for ventilation purposes. However, these roof-extendable hybrid trailers are more closely related to traditional travel trailers than to folding camping trailers and do not typically include fabric (i.e., tented) enclosures or folding panels. The invention to be described in detail herein is intended to encompass the entire field of towable recreational vehicles, whether the form is a travel trailer or fifth-wheeler, folding camping trailer, or hybrid.

It can be appreciated that RV users include in their camping and travel activities outdoor use accessories that may be small in scale such as bicycles and sports equipment, or large in scale such as all terrain vehicles (“ATV's”), motorcycles, snowmobiles, dune buggies, watercraft, etc. As will be quickly apparent, while it may be easy to pack and stow small scale items such as bicycles, the latter class of items provides a packing and hauling challenge to the RV user. To solve the problem of packing and hauling large scale motorized outdoor-use items, often referred to as motorized “toys”, RV users have responded with custom-built or homemade trailers, or by using utility trailers as required to haul their motorized toys into the field. RV manufactures have responded to the toy-hauling dilemma with motorized RV's specifically adapted to haul large scale items. These motorized RV's typically feature a large compartment for the toys and/or juxtaposes a storage area and a living area. Travel trailers and fifth-wheelers have been likewise constructed to serve the non-motorized trailer market. A rear ramp or rear lift gate is typically used to access the storage area and for ingress and egress of the toys.

Due to the complexity of folding camping trailer design, manufacture, and operation, adding a large scale toy-hauling capability to a folding camping trailer has proven to be a challenging problem for RV manufactures. This is primarily due to the smaller size and lighter weight of folding camping trailers when compared to a motorized RV, travel trailer, or fifth-wheeler. It is difficult to add substantial toy hauling capability to a folding camping trailer without sacrificing living space and the accompanying diminishment of creature comforts and conveniences anticipated by RV users today. This difficulty is compounded by the expectation by folding camping trailer users for a vehicle that is light in weight, easy to tow, and relatively less expensive than its larger cousins. Towability, cost, and weight issues are particularly important in the folding camping trailer market segment.

Several examples of trailers that are specifically adapted to haul outdoor use motorized toys will now be discussed. One known travel trailer with a motorized toy hauling capability is manufactured by Thor California and sold under the brand name “Wanderer Pak Rat”. This travel trailer provides a hard-sided living area adjacent an open deck space adapted to stow one or more ATV's and like vehicles. A tented, tip-out sleep area is provided in the living area. However, even with this additional area, space is at a premium in the living area. Additionally, the large frontal area of the hard-sided living area causes substantial wind-resistance and increases fuel consumption for the towing vehicle. Further, the deck space area of the travel trailer is formed of open mesh material limiting the usefulness of this area as potential living space.

Another product known in the folding camping trailer and travel trailer industry is sold under the brand name “Kamparoo Cub” and is substantially a folding camping trailer with a hinged solid lid used to protect a fabric living area during towing/travel. This solid lid is also used as an off-ground floor surface for a portion of the erected living enclosure. The lid may be used as a support surface for the toy accessories in the travel configuration of the trailer. This travel configuration is disadvantageous because the positioning of a heavy motorized toy accessory, such as a motorcycle or ATV, raises the center of gravity of the folding camping trailer, which makes the folding camping trailer difficult and dangerous to tow. Moreover, the design of this folding camping trailer requires the accessories be unloaded before the living area can be extended to the raised position.

Another solution to the motorized toy-hauling dilemma has involved retrofitting conventional multi-purpose cargo trailers with a tent area that is erected on the deck of the trailer once the toys have been unloaded in the field. Such retrofits are devoid of creature comforts provided by the most basic of folding camping trailers and expected by RV users today. Additionally, significant time and effort must be expended to erect the tent area on the trailer deck area. The erected living area of the folding camping trailer manufactured by Thor California discussed previously is similar to this type of bare-bones tent structure.

Some folding camping trailer manufacturers and owners have designed toy hauling structures or created homemade retrofit hauling structures, respectively, that support a motorized toy on top of the roof section when this section is in the retracted or closed position. Typically, in such constructions, an additional frame structure is added to the chassis of the folding camping trailer which extends from the leading end to the trailing end of the chassis and supports the toy at a position above the roof section of the folding camping trailer. This type of structure is disadvantageous and dangerous during towing as the resulting folding camping trailer has a high center of gravity. Additionally, the entire frame structure must be disassembled before the living area of the living enclosure can be erected, and then re-erected when it is time to pack up the toy accessories.

U.S. Pat. No. 6,722,726 to Parmer discloses a toy-hauling trailer in which the trailer's living area is used as both a living area and a toy storage area, which is impractical for most RV users. Additionally, since motorized toys require a wide deck area for storage, there is little to no room available within the living area to support furniture and like creature comforts. Moreover, the floor of the living area is likely to quickly become soiled by dirt, oil, and grease that undoubtedly will accompany the storage of motorized toys.

United States Patent Publication No. 2003/0184055 to Badger et al. discloses a convertible combination utility/cargo trailer that allows for the erection of a tent area. The tent area is erected on the deck of the trailer once the toys have been unloaded in the field and is similar to the retrofit solution discussed previously. The convertible utility/cargo trailer disclosed by this publication suffers from the same disadvantages as those discussed previously, namely the inability to set up the tent area until the toys are off-loaded and the bare-bones tented living area which is devoid of creature comforts and amenities. Moreover, the process of setting up the tented area is complex and manually arduous. U.S. Pat. No. 4,273,351 to Salamander discloses an older, yet similar multi-purpose flatbed trailer design having the capability of accepting a tent structure on the cargo carrying surface.

U.S. Pat. No. 6,283,537 to DeVore, III discloses a multi-purpose utility trailer in which large scale accessories may be stored internally within the trailer in much the same manner as that disclosed by Parmer. However, once again, the accessories must be off-loaded before the living area may be set up. Additionally, due to the size of the accessories, only limited interior cabinetry and galley provisions may be provided in the trailer, diminishing the creature comforts available to the user.

U.S. Pat. Nos. 4,133,577 to Pilant; 3,144,150 to Cox; 2,881,023 to Gile et al.; and 2,669,480 to Messick all predate the advent and popularity and widespread use of motorized toys such as ATV's, motorcycles, or snowmobiles, but are directed to solving problems associated with hauling small boats on a trailer intended for use as a camping shelter.

In view of the foregoing there is a need for a towable trailer, for example, a folding camping trailer, that has enhanced hauling capability for transporting both small and large scale outdoor use accessories, but does so without substantially affecting towability, ease of use, and creature comforts that RV users have come to expect in the field.

### SUMMARY OF THE INVENTION

One embodiment of the invention is directed to a towable trailer, such as a folding camping trailer, with enhanced accessory hauling capability, and which is adapted to be pulled by a motorized vehicle. The trailer includes an elongated chassis and a trailer body attached to the chassis. The trailer body includes two sidewalls, two connecting end walls, a roof portion, and base. The sidewalls, end walls, roof portion, and base define an internal living space of the trailer body. The trailer body further includes at least one slide-out area extendable outward from at least one of the sidewalls of the trailer body for expanding the living space of the trailer body. Further, a deck is attached to the chassis immediately adjacent one of the end walls of the trailer body, and is sized to accommodate one or more outdoor use accessories thereon. The at least one slide-out area is configured to be moved to the extended position with the one or more outdoor accessories positioned on the deck.

When the trailer is in the form of a folding camping trailer, the internal living space of the trailer body is ready for occupancy when the roof portion is disposed in the extended position, and the slide-out area increases the available living space when the roof portion is in the extended position. In the folding camping trailer embodiment, the roof portion and slide-out area are configured to be moved to their extended and retracted positions with the one or more outdoor accessories positioned on the deck.

The trailer may include a ramp associated with the deck for loading and unloading accessories to and from the deck. The ramp may be pivotally connected to the deck and have sufficient length to contact the ground.

The trailer may include a plurality of panels pivotally attached to the deck for forming at least a partial perimeter wall around the deck in a raised position of the panels. The panels may each comprise a mesh area forming at least a portion of the panels.

The trailer may include at least a pair of outriggers disposed at each of the opposite ends of the chassis for supporting and stabilizing the deck and trailer body. A door may be provided in the trailer body to face the deck.

The trailer body may include a flexible enclosure extending from the roof portion to the sidewalls and end walls of the trailer body for enclosing the living space of the trailer body. The trailer body may include a retractable canopy adapted to extend from the roof portion of the trailer body over at least a portion of the deck as a weather protector. Moreover, the trailer body may include an extended flexible enclosure adapted to extend from the roof portion and end wall of the trailer body facing the deck to a position enclosing at least a portion of the deck.

Still other desirable features and advantages of the present invention will become clear upon reading the following detailed description in conjunction with the accompanying drawings, wherein like reference numerals represent like elements throughout.

### BRIEF DESCRIPTION OF THE DRAWINGS

FIG. 1 is a perspective view of a towable trailer in accordance with the present invention and illustrated as a folding camping trailer with enhanced accessory hauling capability.

FIG. 2 is a perspective view of the trailer of FIG. 1 showing a trailer body, deck area, and access ramp of the trailer.

FIG. 3 is a perspective view of the trailer of FIG. 1 showing the deck area fully exposed.

FIG. 4 is a perspective of the trailer of FIG. 1 showing a rear facing end of the trailer body and deck area.

FIG. 5 is a perspective view of the trailer of FIG. 1 showing a front end of the trailer.

FIG. 6 is a perspective view of the trailer of FIG. 1 showing the trailer body with a folding camper component ready for occupancy.

FIG. 7 is an internal perspective view of the folding camper component of the trailer body.

FIG. 8 is a perspective view of the trailer of FIG. 1 showing the folding camper component with a retractable enclosure forming an enclosed additional living area on the deck area of the trailer.

FIG. 9 is a perspective view of the trailer of FIG. 1 showing the folding camper component with a retractable canopy in place of the retractable enclosure of FIG. 8.

### DESCRIPTION OF THE PREFERRED EMBODIMENTS

For purposes of the description herein, spatial or directional terms shall relate to the invention as it is oriented in the drawing figures. However, it is to be understood that the invention may assume alternative variations, except where expressly specified to the contrary. It is also to be understood that the specific apparatus illustrated in the attached drawings, and described in the following specification, are simply exemplary embodiments of the invention. Hence, specific dimensions and other physical characteristics related to the one or more embodiments disclosed herein are not to be considered as limiting.

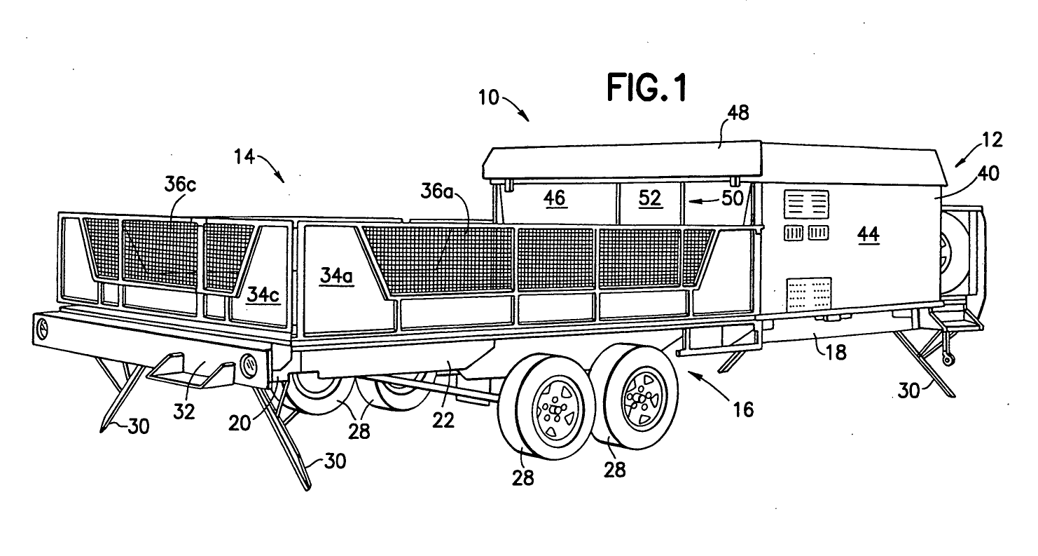

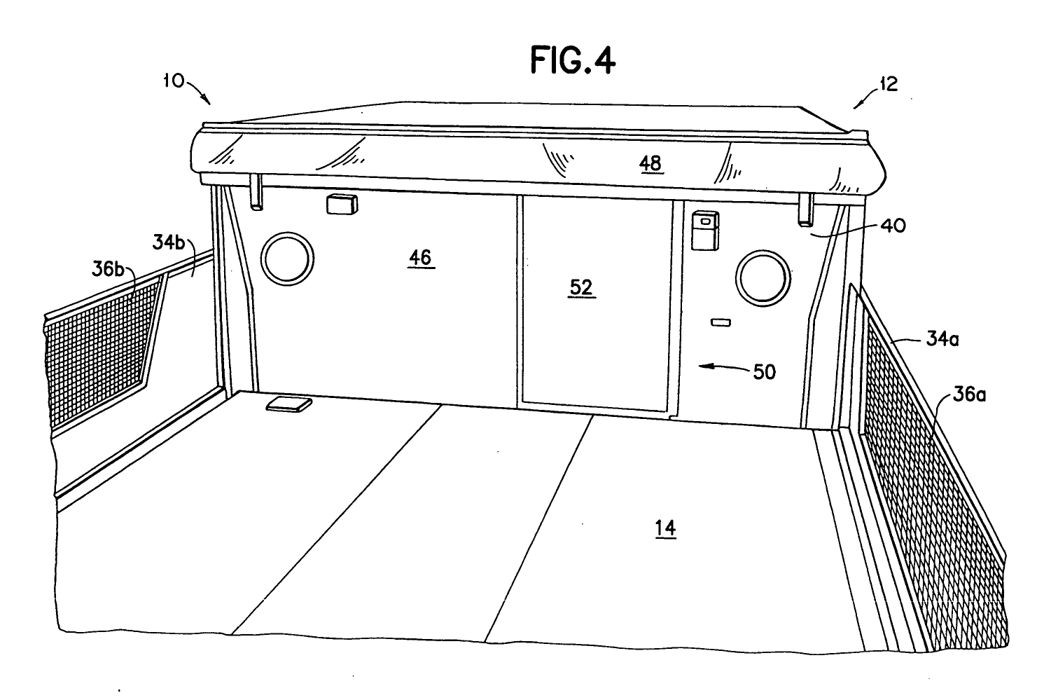

FIGS. 1-7 generally depict a towable trailer 10 (hereinafter “trailer 10”) in accordance with an embodiment of the invention. In FIGS. 1-7, the trailer 10 is illustrated as a folding camping trailer for exemplary purposes. Thus, the trailer 10 may take other forms including a travel trailer, fifth-wheeler, or hybrid vehicle in accordance with the proceeding discussion of the related art.

The trailer 10 generally includes a trailer body 12 which is illustrated in the accompanying figures as a folding camper component and will be referred hereinafter as a “folding camper 12”. A deck 14 is attached to a chassis 16 of the trailer 10 proximate to the folding camper 12. Specifically, the folding camper 12 is attached to the chassis 16 immediately adjacent the deck 14, along the longitudinal length of the chassis 16. As shown in the accompanying Figures, the deck 14 may form the rearward component or area of the trailer 10 and the folding camper 12 may form the forward component or area of the trailer 10.

The chassis 16 may be of a standard design. Typically, the chassis 16 includes a plurality of interconnected structural frame elements that form the structure for supporting the folding camper 12 and deck 14, and items that may loaded on the deck 14. The interconnected frame elements are preferably formed of sufficiently strong supporting material, such as steel, to support the folding camper 12, the deck 14, and any objects and/or individuals thereon. However, the material and construction of the chassis 16 may be designed to provide the most efficient towing capacity to weight ratio. Generally, the chassis 16 includes at least a front portion or structure 18, a rear portion or structure 20, and lateral or side portions or structures 22.

The front portion 18 of the chassis 16 generally supports the folding camper 12, and the rear portion 20 generally supports the deck 14. The front portion 18 of the chassis 16 includes a hitch assembly 24 extending therefrom providing the means for towing the trailer 10. The folding camper 12 may be spaced from the hitch assembly 24 a sufficient clearance distance to allow a hitch 26 of the hitch assembly 24 to be removably coupled by a motorized towing vehicle (not shown) to tow the trailer 10.

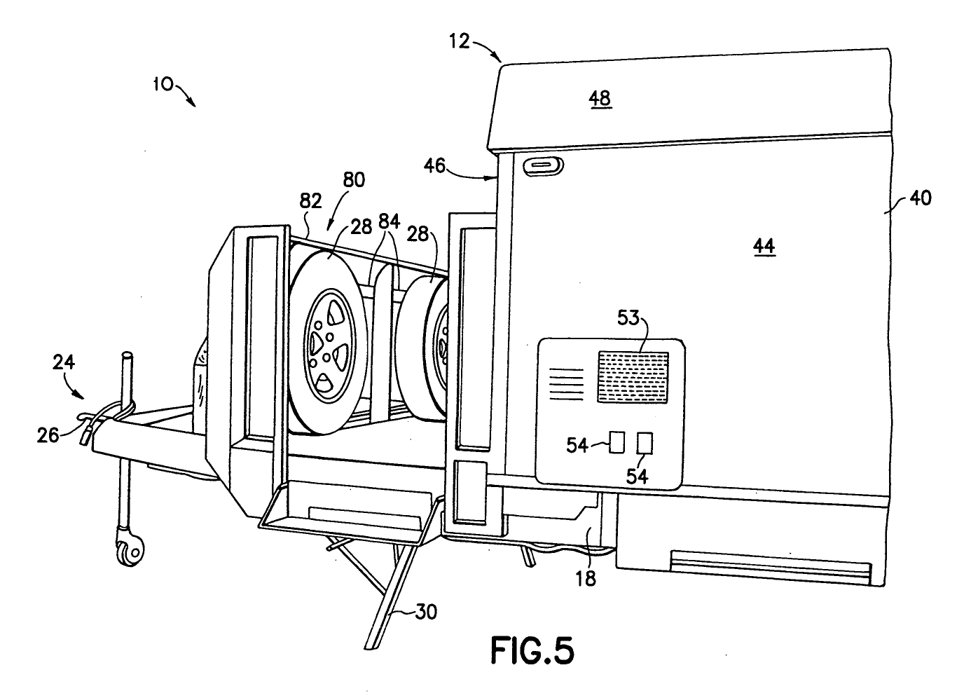

The chassis 16 further includes one or two pairs of wheels 28, for example, situated below the deck 14 for supporting loads thereon and, obviously, for the mobility of the trailer 10. The number of pairs of wheels 28 provided to support the chassis 16 will be dependent on the size and weight of the folding camper 12 and the intended loads to be carried on the deck 14, and the illustration of two pairs of wheels 28 is only exemplary for explaining this feature of the invention. Thus, only one set of wheels 28 may be provided on the folding camper 12. As best shown in FIG. 5, one or more storage compartments may be associated with the chassis 16 as, for example, situated beneath the folding camper 12. Additionally, the chassis 16 may include one or more pairs of outriggers 30. The outriggers 30 may extend downward from underneath the chassis 16 at locations on the front portion 18 and the rear portion 20 of the chassis 16. The outriggers 30 provide additional support to the folding camper 12 and deck 14, particularly when the folding camper 12 is erected for use and when a load is present on the deck 14. The outriggers 30 also stabilize the trailer 10 in the set up configuration and prevent forward or backward movement due to the wheels 28 and, therefore, act as chocks.

The deck 14 is generally a solid and elongated rectangular member that is either of a unitary or a multiple piece construction. However open mesh materials may also be utilized for the deck 14. The deck 14 may include D-rings 31 for tie-downs used to secure large accessories such as ATV's, motorcycles, or snowmobiles to the deck 14. The D-rings 31 are just one example of suitable tie-downs and the deck 14 may include other suitable tie-down devices for securing large or small sized outdoor use accessories. The deck 14 may embody various dimensions, however the deck 14 is typically sized to accommodate three to four ATVs or two snowmobiles of average size. The type and number of accessories that may be accommodated on the deck 14 is only limited by the size of deck 14 and cargo load capacity rating, which will be limited by the permissible length and width and weight-carrying capacity of the chassis 16, all of which may be governed by applicable laws of the individual States in the United States and/or the Federal government.

As illustrated in the accompanying Figures and indicated previously, the deck 14 may be permanently affixed to the chassis 16 and substantially to the rear portion 20 of the chassis 16, and the folding camper 12 may be permanently affixed to the chassis and substantially to the front portion 18. Suitable techniques for permanently securing the folding camper 12 and deck 14 to the chassis 16 include welding. However, the trailer 10 may be constructed to allow the deck 14 and the folding camper 12 to be removed from the chassis 16, for example, through the use of removable mechanical fasteners (i.e., bolts). This allows for replacement decks or other fixtures to be attached to the chassis 16. The folding camper 12 and deck 14 may have substantially the same width dimension as the chassis 16 or may extend outward beyond the width dimension defined by the side portions 22 of the chassis 16. Likewise, the deck 14 may extend to the rear portion 20 of the chassis 16, beyond the rear portion 20 of the chassis 16, or stop short of the rear portion 20 to allow room for a rear bumper 32 as illustrated in the Figures.

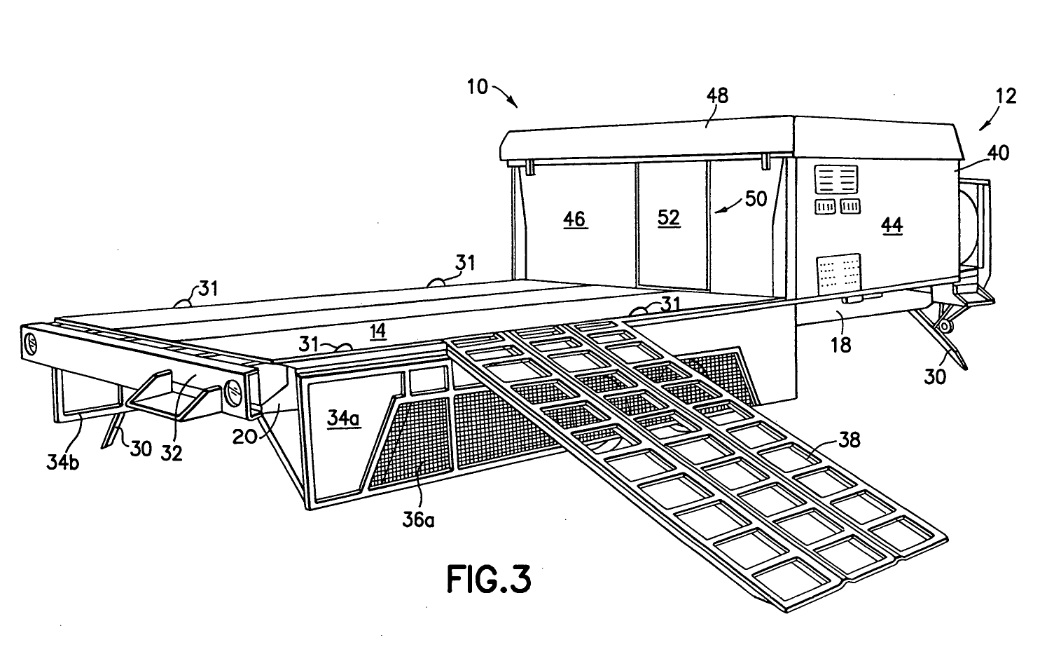

The deck 14 may include one or more side panels 34, such as panels 34a-c pivotally or removably connected to the rear portion 20 and lateral portions 22 of the chassis 16, or pivotally connected to the deck 14 itself. The panels 34a-c may be configured to form a complete or partial perimeter wall to contain any objects disposed on the deck 14 for transport. The panels 34a-c prevent objects from falling off the deck 14 during towing or when the trailer 10 is set up at its intended location. The panels 34a-c may be of solid or partially solid construction, for example, optionally including a mesh section or area 36a-c for enable viewing of the objects on the deck 14. Additionally, the rear end panel 34c may include the mesh section of area 36c to reduce drag on the trailer 10 during towing. The panels 34a-c typically span the length of the sides and rear of the deck 14. As shown in FIG. 3, the side panels 34a, 34b may be pivoted to positions depending or hanging downward from the lateral portions 22 of the chassis 16. The side panels 34a, 34b may include suitable pivotal structures, such as hinges, to form a pivotal connection with the respective lateral portions 22 of the chassis 16 or the deck 14. The side panels 34a, 34b may be locked or latched to the rear panel 34c, the deck 14, and/or to the folding camper 12 to secure the side panels 34a, 34b in place along the sides of the deck 14. The rear panel 34c may be entirely removable from the chassis 16 to permit easy loading and unloading of motorized accessories as discussed herein.

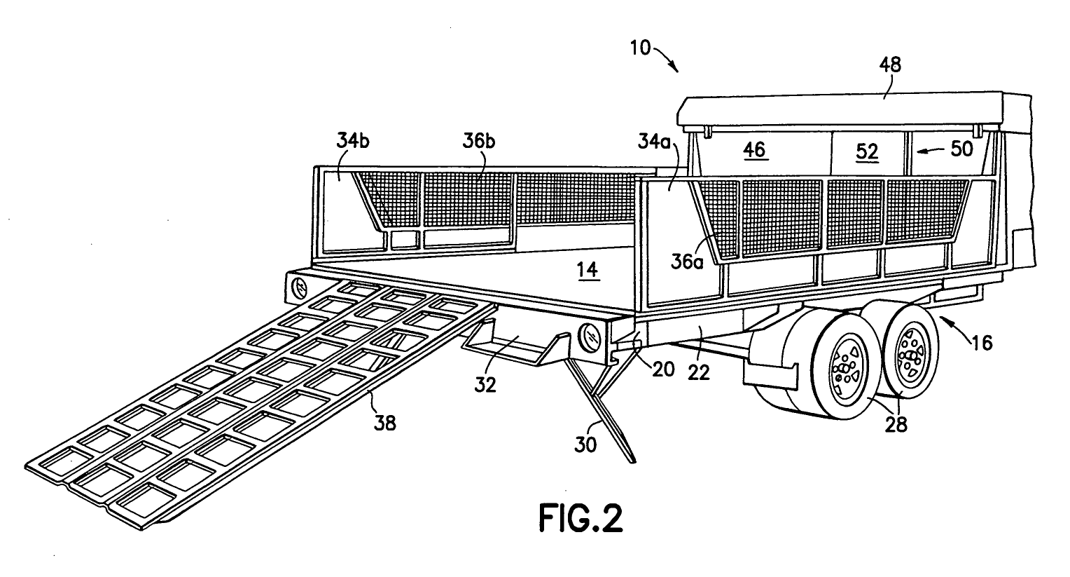

The rear bumper 32 and side or lateral portions 22 of the chassis 16 are adapted to removably receive a loading ramp 38. The ramp 38 in its extended configuration extends from the rear bumper 32 or one of the lateral portions 22 of the chassis 16 to the ground, allowing for easy loading and off-loading of the accessories and equipment from the deck 14. It will be appreciated that other off-loading devices may be utilized in place of the ramp 38 as, for example, steps and lifts. The trailer 10 may be adapted to store the ramp 38 either externally or internally. For example, the ramp 38 may be slidably received into the chassis 16 when not in use. The ramp 38 may include simple hook structures for engaging the rear bumper 32 or lateral portions 22 to secure the ramp in engagement with these structures. Alternatively, the ramp 38 may be adapted for pivotal connection via, for example, a hinged connection (not shown) with rear bumper 32, as shown in FIG. 2, or lateral portions 22 or, optionally, with the deck 14 as generally illustrated in FIG. 3.

The foregoing side and rear panel 34a-c configuration provides maximum accessibility to the deck 14 and loading and unloading of equipment and accessories of all sizes. The open nature of the deck 14 allows, for example, multiple ATV's to be loaded transverse to the longitudinal axis of the deck 14 by positioning the ramp 38 along one of the sides of the deck 14 rather than the rear end of the deck 14 as depicted in FIG. 3. This type of loading arrangement was not previously possible in the art. For example, attempting to load the same three ATV's onto the deck 14 by utilizing the configuration shown in FIG. 2 would present some difficulty because there is insufficient room lengthwise on the deck 14 to accommodate three ATV's in an inline orientation. Attempting to rotate the three ATV's to orient them in a transverse direction to the lengthwise direction of the deck 14 would be a challenging endeavor and require significant “muscling” by the RV owner/user. However, these aforementioned difficulties can be ameliorated by locating the ramp 38 along one of the sides of the deck 14 with the side panels 34a, 34b in their pivoted orientations depending downward from the deck 14 and along chassis 16.

The folding camper 12 may be of relatively similar design and construction as folding campers known in the art, and a suitable example for the folding camper 12 may be found in U.S. Pat. No. 6,217,106 to Reckner, Jr. previously incorporated by reference. The folding camper 12 has a solid lower body structure 40 comprised by a base 42, two partial-height rigid sidewalls 44, two partial height rigid end walls 46, and a vertically extendable solid roof section 48. In the travel configuration, the base 42, side and end walls 44, 46, and roof section 48 form a protective enclosure for the contents of the folding camper 12. At least one of the sidewalls and end walls 44, 46 includes a door 50 for accessing the living area or space defined by the folding camper 12. The door 50 may include a solid lower panel 52. The exterior of the folding camper 12 may include lights 53 and electrical outlets 54.

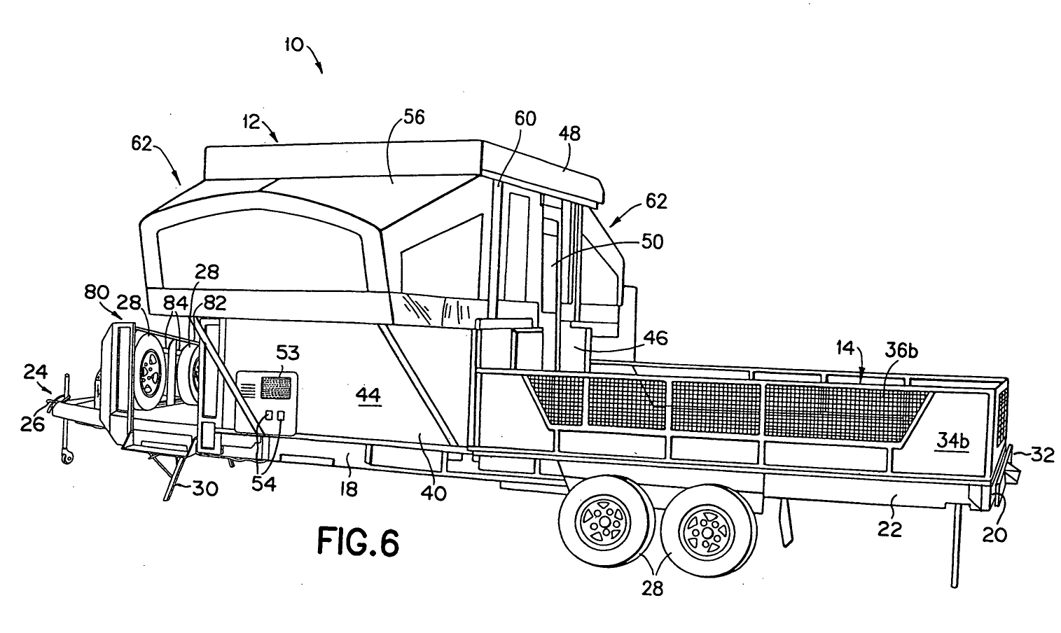

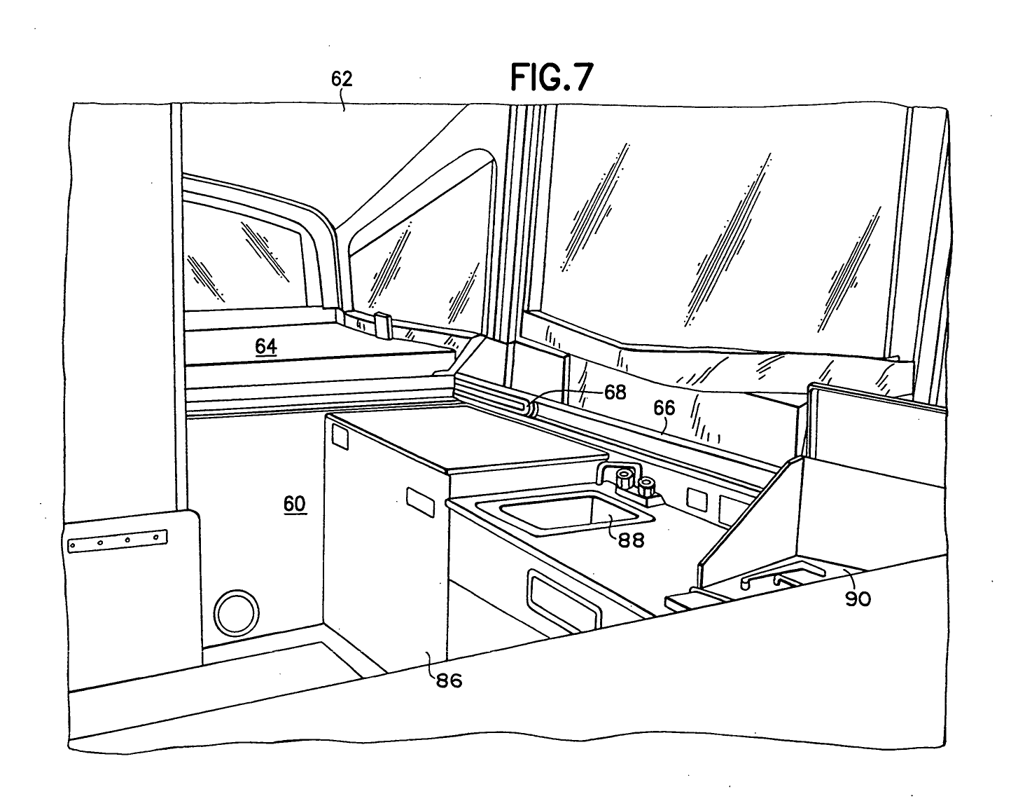

The folding camper 12 is shown in the set-up or extended configuration and ready for occupancy in FIG. 6. The roof section 48 may be extended to a raised configuration by conventional apparatus known in the art, for example, by use of a manual or electric lifting mechanism (not shown) employing foldable or extendable support rods, a spring system, or a pneumatic or hydraulic system. As is conventional in the art, the folding camper 12 includes a flexible fabric enclosure or tented section 56 extending from the roof section 48 to the sidewalls 44 and end walls 46, and which in combination with the sidewalls 44 and end walls 46 defines an internal living space 60 within the folding camper 12 as shown in FIG. 7. The sidewalls 44 may house extendable sleeping areas or slide-out areas 62 for increasing the internal living space 60 within the folding camper 12. The internal living space 60 may include dining, galley, and sitting areas as are known from the Reckner, Jr. patent. The flexible enclosure 56 may be constructed of any suitable flexible weather-resistant material. A suitable equivalent to the flexible enclosure 56 is the use of folding panels deployed between the partial height side and end walls 44, 46 and the roof section 48. The flexible enclosure 56 or folding panels are configured to be stowed underneath the roof section 48 when the folding camper 12 is in the travel configuration. The base 42, side and end walls 44, 46, flexible enclosure 56, and roof section 48 define an enclosed, temporary, and semi-self-sufficient living area or space 60 conducive to camping.

The slide-outs 62 provide extendable sleeping areas that may support beds or mattresses 64. The slide-outs 62 may utilize an extension rail/channel system to extend outward beyond the sidewalls 44 of the folding camper 12. Specifically, two C-shaped channels 66 may be attached to the interior sides of the end walls 46. Corresponding extension rails 68 are attached to opposite sides of the slide-outs 62. The extension rails 68 are slidably received within the channels 66 to allow movement of the extension rails 68 within the channels 66. As illustrated, the slide-outs 62 may extend from both sidewalls 44 of the folding camper 12. However, the folding camper 12 may be configured such that only one slide-out 62 is provided, for example, adapted to extend outward from only one of the sidewalls 44 of the folding camper 12 or, optionally, from the front end wall 46 of the folding camper 12 so as not to interfere with object stored on the deck 14.

The folding camper 12 in this embodiment is secured to the front portion 18 of the chassis 16 adjacent to and forward of the deck 14. The width of the folding camper 12 and the deck 14 may be substantially similar for aesthetic, aerodynamic, and safety reasons. The folding camper 12 may be permanently affixed to the front portion 18 of the chassis 16, for example, by welding, or removably associated with the chassis 16, for example, by removable mechanical fasteners. The door 50 may be provided in the end wall 46 facing the deck 14 to allow access to the deck 14 from the internal living space 60. The top portion of the door 50 may be formed by the flexible enclosure 56 or a flip-up panel (not shown) attached to the lower door panel 52. Additional doors (not shown) may be provided in the folding camper 12 to access the living space 60.

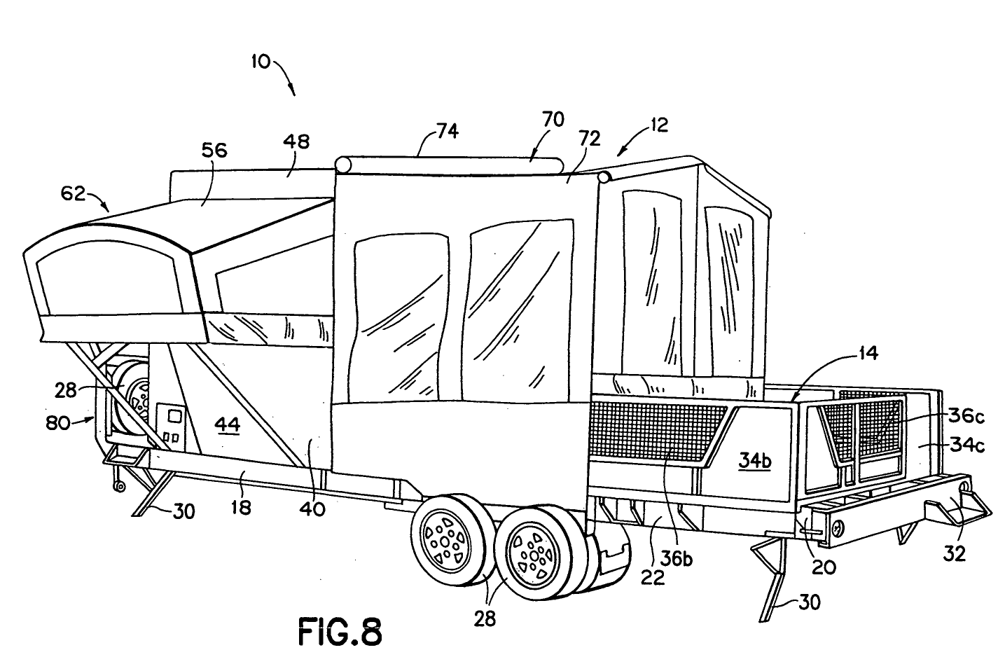

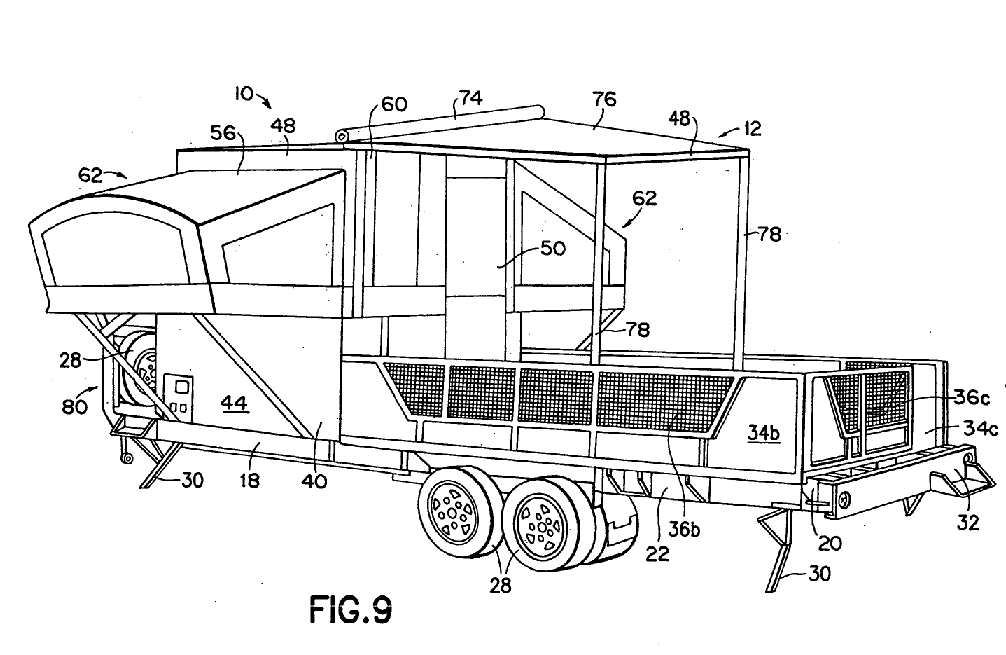

As shown in FIG. 8, an additional living area 70 may be associated with the folding camper 12. The additional living area 70 is configured to extend over and enclose at least a portion of the deck 14. Specifically, the additional living area 70 is formed by an additional, extendable flexible fabric enclosure or tented area 72 that extends from the flexible enclosure 56 associated with the folding camper 12. The additional enclosure 72 may be formed as part of the flexible enclosure 56, or may be a separate structure attached to the end wall 46 facing the deck 14 and the flexible enclosure 56. The additional enclosure 72 effectively expands the usable living space 60 already encompassed by the folding camper 12, and may form a porch area for use by the occupants of the folding camper 12. As indicated, the additional enclosure 72 may cover all of the deck 14 or just a portion of the deck 14. In the latter instance, the uncovered portion of the deck 14 may form a storage area. FIG. 8 shows how the additional enclosure 72 may be shaped to accommodate the geometry of the deck 14, thereby providing a fully enclosed interior space within the enclosure 72. For example, the sides of the additional enclosure 72 may overlap the side panels 34a, 34b of the deck 14. The additional enclosure 72 may be constructed of the same material as the flexible enclosure 56 and may include windows formed by mesh material or see-through solid material. When not in use, the additional enclosure 72 may be folded and stored into a sealable flap or pouch 74 attached to a portion of the roof section 48 facing the deck 14. Although the additional enclosure 72 is adapted to enclose all or a portion of the deck 14, this structure may be substituted with an extendable/retractable canopy 76 that may serve as a roof for the deck 14 and a weather protector, as shown in FIG. 9. The canopy 76 may be supported in the extended/open position by two removable supports 78 that cooperate with openings (not shown) in the deck 14.

The layout of the trailer 10, namely the location of the folding camper 12 and the trailer 14, is conducive to not only independent, but also simultaneous use of the folding camper 12 and the deck 14. Generally, the folding camper 12 may be fully erected and utilized without regard to whether or not accessories of any size or shape are present on the deck 14 because the slide-outs 62 extend from the sidewalls 44 of the folding camper 12 rather than the end walls 46 in traditional folding camping trailers. Additionally, with the roof section 48 in a lowered and locked position, the trailer 10 is still configured as a compact and low profile unit conducive for towing. Specifically, the folding camper 12 provides a low frontal cross-section that promotes improved fuel efficiency over traditional travel trailers and folding camping trailers that store large accessories on their roof rather than in the configuration of the trailer 10. Moreover, the frontal cross-section functions as a protective shield for the accessories stored on the deck 14 by deflecting incidental road debris away from the accessories.

Furthermore, with specific reference to FIG. 5, the trailer 10 may include an optional storage area 80 situated on the front portion 18 of the chassis 16 forward of the folding camper 12. The storage area 80 is formed by a solid end wall 82 that is spaced a distance away from the front end wall 46 of the folding camper 12. The end wall 82 may define one ore more recesses 84 for receiving, for example, items such as spare tires for the chassis 16. Additionally, the storage area 80 may serve a similar function to the deck 14, namely the storage of equipment, supplies, and play accessories for the camping experience. The end wall 82 forming the storage area 80 may serve as a protective barrier for the front end wall 46 of folding camper 12 in much the same manner as the folding camper 12 serves to protect the cargo area defined by the deck 14 and panels 34a-c. However, due to the smaller size of the storage area 80, the storage area 80 is obviously intended to accommodate smaller items rather than motorized toys, such as motorcycles or ATV's. The end wall 82 defining the storage area 80 may be constructed of the same material as the solid sidewalls 44 or end walls 46 of the folding camper 12 or the same rigid material that may be used for the perimeter panels 34a-c on the deck 14. The storage area 80 may be formed by a simple platform such as that disclosed in U.S. Pat. No. 5,979,972 to Gehman assigned to the same assignee as the present application and which is incorporated herein by reference in its entirety. The storage area 80 may be eliminated and the deck 14 expanded, for example, by being elongated along the longitudinal axis of the trailer 10, to maximize the storage/cargo area on the deck 14.

It will be understood that relative proportions between the folding camper 12 and deck 14 may vary depending on the objective to be served by the trailer 10. For example, if a greater enclosed living area 60 is desired, the length of the deck 14 may be reduced to accommodate a larger length folding camper 12, and vice versa. Additionally, it may be possible to maintain the length of the deck 14 and still increase the length of the enclosed living area 60 by removing the forward storage area 80. Such modifications are within the spirit of the present invention relating to the integration and independent or simultaneous use of the folding camper 12 and the deck 14.

As shown in FIG. 7, various structures may be situated within the living area 60 of the folding camper 12 for improving the camping experience. These structures may include, for example, a galley, a dining table and associated seating, a shower and toilet facility, sleeping quarters, and storage for various items. FIG. 7 specifically illustrates how a refrigerator 86, a sink 88, and a stove top 90 may be efficiently incorporated into the living area 60. It is to be understood that some of these structures may provide additional functionality to the folding camper 12. For example, a top portion of the refrigerator 86 may support the slide-outs 62 when the roof section 48 is in a lowered position.

The present invention was described with reference to one or more embodiments of a folding camping trailer having an enclosed living area provided immediately adjacent a storage or cargo area. Those skilled in the art may make modifications and alterations to this concept upon reading and understanding the proceeding detailed description. It is intended that the invention be construed as including all such modifications and alterations insofar as they come within the scope of the appended claims or the equivalents thereof.

The invention claimed is:

1. A folding camping trailer with enhanced accessory hauling capability comprising:
an elongated chassis;
a trailer body attached to the chassis and comprising two sidewalls, two connecting end walls, an extendable roof portion, and base, the sidewalls, end walls, roof portion, and base defining an internal living space of the trailer body when the roof portion is disposed in the extended position, the trailer body further comprising at least one slide-out area extendable outward from at least one of the sidewalls of the trailer body for expanding the living space of the trailer body when the roof portion is in the extended position; and
a deck attached to the chassis immediately adjacent one of the end walls of the trailer body, the deck sized to accommodate one or more outdoor use accessories thereon;
wherein the roof portion and slide-out area are configured to be moved to their extended and retracted positions with the one or more outdoor use accessories positioned on the deck.

2. The folding camping trailer of claim 1, comprising a ramp associated with the deck for loading and unloading accessories to and from the deck.

3. The folding camping trailer of claim 2, wherein the ramp is pivotally connected to the deck and has sufficient length to contact the ground.

4. The folding camping trailer of claim 1, comprising a plurality of panels pivotally attached to the deck for forming at least a partial perimeter wall around the deck in a raised position of the panels.

5. The folding camping trailer of claim 4, wherein the panels each comprise a mesh area forming at least a portion of the panels.

6. The folding camping trailer of claim 1, comprising a shielded storage area situated on the chassis adjacent the other end wall of the trailer body.

7. The folding camping trailer of claim 1, wherein the trailer body comprises a door facing the deck.

8. The folding camping trailer of claim 1, wherein the trailer body comprises a flexible enclosure extending from the roof portion to the sidewalls and end walls of the trailer body for enclosing the living space of the trailer body.

9. The folding camping trailer of claim 1, comprising a retractable canopy adapted to extend from the roof portion of the trailer body over at least a portion of the deck as a weather protector.

10. The folding camping trailer of claim 1, comprising an extended flexible enclosure adapted to extend from the roof portion and end wall of the trailer body facing the deck to a position enclosing at least a portion of the deck.

11. A trailer with enhanced accessory hauling capability adapted to be pulled by a motorized vehicle, comprising:
an elongated chassis;
a trailer body attached to the chassis and comprising two sidewalls, two connecting end walls, a roof portion, and base, the sidewalls, end walls, roof portion, and base defining an internal living space of the trailer body, the trailer body further comprising at least one slide-out area extendable outward from at least one of the sidewalls of the trailer body for expanding the living space of the trailer body; and
a deck attached to the chassis immediately adjacent one of the end walls of the trailer body, the deck sized to accommodate one or more outdoor use accessories thereon;
wherein the at least one slide-out area is configured to be moved to the extended position with the one or more outdoor use accessories positioned on the deck.

12. The trailer of claim 11, comprising a ramp associated with the deck for loading and unloading accessories to and from the deck.

13. The trailer of claim 12, wherein the ramp is pivotally connected to the deck and has sufficient length to contact the ground.

14. The trailer of claim 11, comprising a plurality of panels pivotally attached to the deck for forming at least a partial perimeter wall around the deck in a raised position of the panels.

15. The trailer of claim 14, wherein the panels each comprise a mesh area forming at least a portion of the panels.

16. The trailer of claim 11, comprising a shielded storage area situated on the chassis adjacent the other end wall of the trailer body.

17. The trailer of claim 11, wherein the trailer body comprises a door facing the deck.

18. The trailer of claim 11, wherein the trailer body comprises a flexible enclosure extending from the roof portion to the sidewalls and end walls of the trailer body for enclosing the living space of the trailer body.

19. The trailer of claim 11, comprising a retractable canopy adapted to extend from the roof portion of the trailer body over at least a portion of the deck as a weather protector.

20. The trailer of claim 11, comprising an extended flexible enclosure adapted to extend from the roof portion and end wall of the trailer body facing the deck to a position enclosing at least a portion of the deck.
